(19) United States
(12) Patent Application Publication
(10) Pub. No.: US 2026/0266303 A1
(43) Pub. Date: Sep. 10, 2026

(54) METHOD FOR DETECTING A DEPOSITION LAYER AND ASSOCIATED TURBOMOLECULAR VACUUM PUMP

(71) Applicant: PFEIFFER VACUUM, Annecy (FR)

(72) Inventors: Pierre-Emmanuel CAVAREC, Annecy Cedex (FR); Nicolas VARENNES, Annecy Cedex (FR)

(73) Assignee: PFEIFFER VACUUM, Annecy (FR)

(21) Appl. No.: 19/137,428

(22) PCT Filed: Nov. 8, 2023
(86) PCT No.: PCT/EP2023/081187

§ 371 Date: Jun. 10, 2025

(30) Foreign Application Priority Data
Dec. 16, 2022 (FR) FR2213612

(51) Int. Cl. F04D 27/00; F04D 19/04

(52) U.S. Cl. CPC F04D 27/001; F04D 19/042; F04D 27/008

(57) ABSTRACT

A method detects a deposition layer in a turbomolecular vacuum pump including a stator, a rotor, and at least one temperature sensor. The method includes the following steps: the temperature sensor measures and transmits a temperature representative of the temperature of the rotor to the monitoring unit, the monitoring unit calculates a drift of the temperature with respect to time and compares it to a predefined threshold, when the value of the calculated drift is greater than or equal to the predefined threshold, the monitoring unit detects an abnormal overheating representative of a deposition layer and issues at least one alert signal and/or command to stop the pump.

### TECHNICAL FIELD

The present invention relates to a turbomolecular vacuum pump. The invention relates in particular to a method for detecting a deposition layer in such a turbomolecular vacuum pump.

### TECHNICAL BACKGROUND

The generation of a high vacuum in a chamber necessitates the use of turbomolecular vacuum pumps composed of a stator in which a rotor is driven in fast rotation, for example a rotation at more than thirty thousand revolutions per minute.

In some methods in which the vacuum pumps are used, such as the semiconductor or LED manufacturing methods, a deposition layer can form in the vacuum pumps. The deposition layer can heat up the rotor by friction, which can generate creep therein, then possible cracking.

It is known practice to heat up the stator and the pipelines to avoid the condensation of reaction products in the pumps. The limitation of temperature below the admissible temperatures for the rotor makes it possible to reduce the formation of depositions in the pump but without totally preventing it however.

Regular maintenance works must therefore be scheduled to frequently clean the vacuum pump. These maintenance works are however contrary to the production rate imperatives. Ways to monitor the formation of depositions in the vacuum pumps are consequently sought in order to space apart the intervals between maintenance works as much as possible. One of the difficulties however is that it is not possible to observe the interior of the vacuum pumps without having to stop them to wholly or partly dismantle them. In addition, in some applications, the exposure of the interior of the vacuum pump to the open air can be hazardous.

Several known sensor technologies make it possible to monitor these depositions and their growth in the vacuum pumps.

In the case of the turbomolecular vacuum pumps, one known method consists in measuring the current of the motor or the positions of the magnetic levitation rotor in order to determine the possible presence of byproducts. Changes to the current of the motor or to the positions of the magnetic levitation rotor can supply information on the presence of depositions. This strategy can however not be sufficiently precise, notably because the increase in current is generally detected much too late, only a few seconds or fractions of seconds before the crash, which may not allow timely intervention.

### SUMMARY OF THE INVENTION

One of the aims of the present invention is to propose an alternative that makes it possible to rapidly detect the formation of a deposition layer in a turbomolecular pump so as to give a warning as to when a cleaning of the turbomolecular pump is necessary.

To this end, the subject of the invention is a method for detecting a deposition layer in a turbomolecular vacuum pump comprising a stator and a rotor configured to revolve in the stator, and at least one temperature sensor arranged in the stator so as to measure a temperature. It may be a temperature representative of the temperature of the rotor, and notably be the temperature of the rotor. The at least one temperature sensor is configured to transmit at least one measurement of said temperature to a monitoring unit of said pump.

According to the invention, said method comprises the following steps:
the at least one temperature sensor measures said temperature and transmits the measurement of said temperature to the monitoring unit,
from measurements of said temperature transmitted by the at least one temperature sensor, the monitoring unit calculates a drift of the temperature with respect to time,
the monitoring unit compares the value of said calculated drift to a predefined threshold,
when the value of said calculated drift is greater than or equal to the predefined threshold, the monitoring unit detects an abnormal overheating representative of a deposition layer and issues at least one alert signal and/or at least one command signal to stop said pump.

The deposition layer can for example be formed on the stator, notably on a part of the stator facing a cylindrical skirt of the rotor, such as a Holweck skirt. It can notably be a low part of the stator according to an axis of rotation of the rotor, the high part being situated on the side of a suction inlet of said pump.

Said method can further comprise one or more of the following features described hereinbelow, taken separately or in combination.

Said pump can comprise magnetic bearings configured to guide the rotor in rotation about the axis of rotation. The monitoring unit can control the magnetic bearings to offset the axis of rotation for a predefined time in at least one direction at right angles to the axis of rotation or on a circular trajectory.

The term “offset” is understood to mean the fact of shifting/displacing the axis of rotation parallel to its initial position. The initial position is central or substantially central between the magnetic bearings.

The temperature measurement step can be implemented at least when the axis of rotation is offset.

At the end of the offsetting control, the monitoring unit can control the magnetic bearings such that the axis of rotation reverts to the initial position, central or substantially central between the magnetic bearings.

The alert signal and/or the stop command signal can be generated at said pump.

The monitoring unit can transmit the alert signal and/or the stop command signal to at least one piece of equipment linked to said pump.

Said signal can be digital and/or analogue.

Said signal generated at said pump can be a visual and/or sound signal.

The predefined threshold can be less than or equal to 2° C./min.

The predefined threshold can notably lie between 0.3° C./min and 2° C./min.

According to one embodiment, the predefined threshold can be set. As an example, the set predefined threshold can be 2° C./min.

According to one embodiment, the predefined threshold can be variable and a function of a motor current consumed by a motor of said pump configured to drive the motor in rotation.

According to yet another embodiment, the predefined threshold can be set at least in a first iteration of the method, and the predefined threshold can be variable in at least one next iteration of the method.

The set predefined threshold can be greater than the variable predefined threshold.

The variable predefined threshold can be calculated according to the formula:

$$s ( Imotor ) = a + b \times \frac{Imotor}{Imax} ° C . / min ,$$

with a corresponding to a first coefficient, b corresponding to a second coefficient, Imotor corresponding to the motor current, Imax corresponding to the maximum value of the motor current.

Said variable threshold can be chosen from at least one predefined threshold range.

The first coefficient can be equal to the minimum bound of the threshold range.

The second coefficient can be equal to the maximum bound of the threshold range minus the first coefficient.

The variable threshold can depend also on at least one criterion from among a nature of the pumped gases and/or the temperature representative of the temperature of the rotor at the instant when said drift is calculated.

The first coefficient can be reduced when said temperature measured at the instant when said drift is calculated is greater than or equal to a predetermined temperature.

The invention relates also to a turbomolecular vacuum pump configured to at least partly implement the detection method as defined previously. Said pump comprises a stator, a rotor configured to revolve in the stator, at least one temperature sensor arranged in the stator, a monitoring unit. The at least one temperature sensor is configured to measure a temperature. It may be a temperature representative of the temperature of the rotor, and notably be the temperature of the rotor.

Said pump can be a magnetic bearing pump.

The at least one temperature sensor is configured to transmit the measurement of said temperature to the monitoring unit.

The monitoring unit comprises at least one processing element configured to:
calculate, from measurements of said temperature transmitted by the at least one temperature sensor, a drift of the temperature with respect to time,
compare the value of said calculated drift to a predefined threshold, and
when the value of said calculated drift is greater than or equal to the predefined threshold, detect an abnormal overheating representative of a deposition layer and issue at least one alert signal and/or at least one command signal to stop said pump.

The temperature sensor can be chosen from among an infrared sensor, a magnetothermal sensor, and a positive temperature coefficient probe.

The monitoring unit can be arranged wholly or partly, inside or outside, a casing of said pump.

### BRIEF DESCRIPTION OF THE DRAWINGS

Other advantages and features of the invention will become more clearly apparent on reading the following description given as an illustrative and nonlimiting example, and the attached drawings in which:

FIG. 1 shows an axial cross-sectional view of a turbomolecular vacuum pump according to an exemplary embodiment.

FIG. 2 is a graph representing the trend as a function of time of the temperature of the rotor and of the drift of the temperature with respect to time.

In these figures, the elements that are identical bear the same reference numbers.

The following embodiments are examples. Although the description refers to one or more embodiments, this does not necessarily mean that each reference relates to the same embodiment, or that the features apply only to a single embodiment. Single features of different embodiments can also be combined or interchanged to provide other embodiments.

In the description, some elements can be indexed, for example first element or second element. In this case, it is a simple indexing to differentiate and name elements that are similar but not identical. This indexing does not imply a priority of one element over another and such naming can easily be interchanged without departing from the scope of the present invention. Nor does this indexing imply any order in time.

### DETAILED DESCRIPTION

### Turbomolecular Vacuum Pump

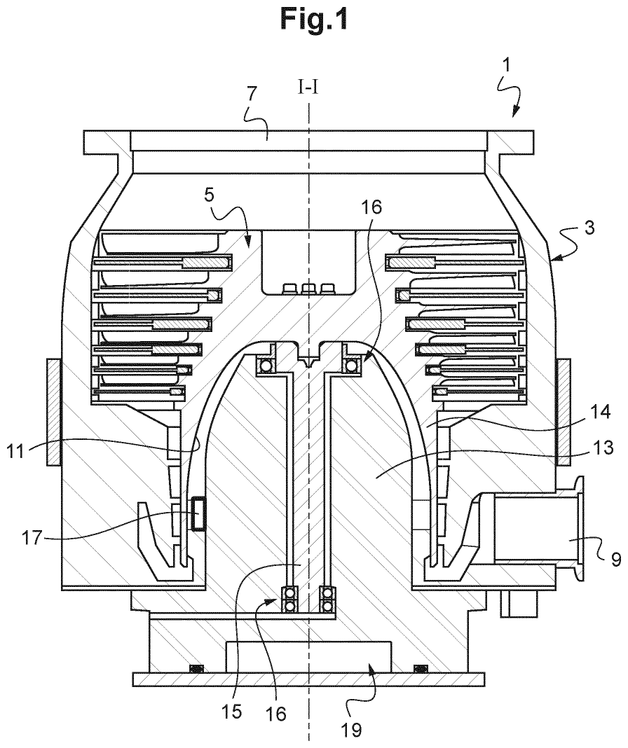

FIG. 1 illustrates an exemplary embodiment of a turbomolecular vacuum pump 1. This turbomolecular vacuum pump 1 is hereinafter designated pump 1.

According to one embodiment, the pump 1 can be a magnetic levitation pump (Maglev pump).

The pump 1 comprises a stator 3 in which a rotor 5 is configured to revolve about an axis of rotation I-I. The rotation is at high speed, for example at more than thirty thousand revolutions per minute.

In operation, the pumped gases enter through a suction inlet 7, passing through stages of the pump 1, to then be discharged to a discharge outlet 9 of the pump 1. The discharge outlet 9 can be intended to be coupled to a primary pumping system.

The rotor 5 can comprise an internal bowl 11 centred about the axis of rotation I-I and having at least one surface arranged facing a bell 13 of the stator 3. According to the example represented, the bell 13 is situated under the internal bowl 11 on the axis of rotation I-I and the orientation of the pump 1 as represented in FIG. 1. In operation, the rotor 5 revolves in the stator 3 without contact between the internal bowl 11 and the bell 13.

The rotor 5 can further comprise a skirt, for example cylindrical, notably a Holweck skirt 14. The Holweck skirt 14 can be formed by a smooth cylinder. In operation, the cylindrical skirt or Holweck skirt 14 can revolve facing grooves, for example helical, of the stator 3. The helical grooves of the stator 3 make it possible to compress and guide the pumped gases to the discharge outlet 9. Under the rotor 5, the internal bowl 11 arranged facing the bell 13 of the stator 2 is then also formed by the interior of the cylindrical skirt or Holweck skirt 14.

The rotor 5 can be fixed to a drive shaft 15 driven in rotation in the stator 3 by an internal motor of the pump 1. The drive shaft 15 passes for example through the bell 13 of the stator 3. The rotor 5 can be guided laterally and axially by magnetic or mechanical bearings 16 supporting the drive shaft 15 of the rotor 5, and situated in the stator 3.

In the case of a magnetic levitation pump (Maglev pump), magnetic bearings 16 can guide the rotor 5 in rotation. These magnetic bearings 16 make it possible to control the position of the axis of rotation I-I of the rotor 5. It is for example possible to keep the axis of rotation I-I at the centre or substantially at the centre of the magnetic bearings 16. It is also possible to offset the axis of rotation I-I in a given direction, for example by modifying a position setpoint of servocontrolling of the axis of rotation I-I.

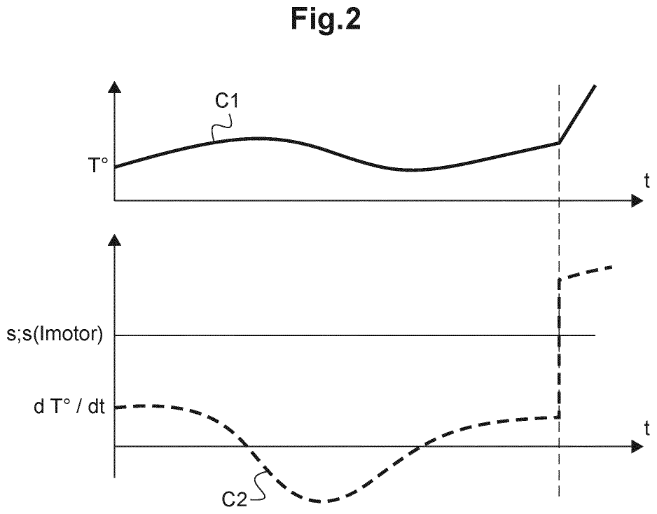

Referring also to FIG. 2, the pump 1 can comprise at least one temperature sensor 17. The temperature sensor 17 is arranged so as to measure at least one temperature T°. It may be the temperature of the rotor 5 or a temperature representative of the temperature of the rotor 5.

The temperature sensor 17 can, if necessary, measure a temperature of the stator 3 and/or of at least one other element of the pump 1.

As an example, it can be an infrared sensor, a magnetothermal sensor, or even a positive temperature coefficient probe.

The temperature sensor 17 can be arranged in the stator 3. It can notably be arranged in a low part of the pump 1 according to the orientation of FIG. 1, more specifically: towards the outlet of the gases where the pressures are highest and therefore the deposition risks are the greatest. According to a particular exemplary embodiment, the temperature sensor 17 can be arranged at the bell 13 of the stator 3 facing the internal bowl 11 of the rotor 5. In particular, the temperature sensor 17 can be arranged, for example, in a low part of the stator 3, so as to measure a temperature representative of the temperature of the low part of the Holweck skirt 14.

A single temperature sensor 17 is represented in the example of FIG. 1 and described hereinbelow. Obviously, several temperature sensors can be provided to measure the temperature T° of the rotor 5.

The temperature sensor 17 can transmit one or more temperature measurements T° to a monitoring unit 19.

The temperature sensor 17 can be a sensor already present in the pump 1 and the temperature measurements of which transmitted to the monitoring unit 19 are notably used to control the temperature of the pump 1 via heating elements, for example resistive or radiative, such as a heating belt or a heating cartridge. It can also be a temperature sensor whose temperature measurements are used to calculate creep of the rotor.

The monitoring unit 19 can be arranged wholly or partly, inside or outside, a casing of the pump 1. In the example illustrated, the monitoring unit 19 is received inside the stator 3 of the pump 1. This arrangement is not limiting.

The monitoring unit 19 can receive the temperature measurement or measurements T° transmitted by the temperature sensor 17.

The monitoring unit 19 can calculate, from temperature measurements T° transmitted by the temperature sensor 17, a drift of the temperature with respect to time

$$\frac{dT °}{dt} .$$

The drift of the temperature with respect to time

$$\frac{dT °}{dt}$$

makes it possible to deduce a thermal power of the rotor 5. In particular, the drift of the temperature with respect to time

$$\frac{dT °}{dt}$$

multiplied by a thermal inertia of the rotor 5 corresponds to the thermal power of the rotor 5. When a deposition layer forms in the vacuum pump 1, this deposition layer can heat up the rotor 5 by friction. Thus, in case of friction, the thermal power is outside of a normal operating range. More specifically, the thermal power exceeds a predefined limit. This is reflected by the drift of the temperature with respect to time

$$\frac{dT °}{dt}$$

exceeding a predefined threshold s, s(Imotor).

The monitoring unit 19 can compare the value of the calculated drift

$$\frac{dT °}{dt}$$

to the predefined threshold s, s(Imotor).

When the value of the calculated drift

$$\frac{dT °}{dt}$$

is greater than or equal to the predefined threshold s, s(Imotor), the monitoring unit 19 can detect an abnormal overheating representative of a deposition layer. Since the drift makes it possible to determine the scale of the variation of the temperature as a function of time, the calculation of the drift thus makes it possible to detect such an overheating rapidly and clearly. Through the calculation of the drift, the temperature variations are amplified and more clearly detectable.

The monitoring unit 19 can issue at least one alert signal and/or at least one command signal to stop the pump 1.

The monitoring unit 19 can comprise one or more processing elements making it possible to perform one or more reception, computation, comparison, detection and issuing actions described hereinabove. It can be a computer, a processor, a microcontroller, or any other unit making it possible to perform these operations.

The monitoring unit 19 can control the magnetic bearings 16 to keep the axis of rotation I-I at the centre or substantially at the centre of the magnetic bearings 16. The monitoring unit 19 can also control the magnetic bearings 16 to offset the axis of rotation I-I in a given direction by modifying the position setpoint of servocontrolling of the axis of rotation I-I. Such control can be advantageous notably in the case of a magnetic levitation pump (Maglev pump).

The pump 1 is configured to at least partly implement a method for detecting a deposition layer in the pump 1.

### Method for Detecting a Deposition Layer

The method for detecting a deposition layer comprises the steps described hereinbelow.

The temperature sensor 17 can measure the temperature T° of the rotor 5 and transmit the temperature measurement or measurements T° to the monitoring unit 19. The curve C1, in solid lines in FIG. 2, shows an example of the trend of the temperature T° of the rotor 5 as a function of time t.

The temperature measurements T° can be transmitted by the temperature sensor 17 to the monitoring unit 19.

The temperature T° of the rotor 5 can be measured continuously, when the pump 1 is operating.

Alternatively, the temperature T° of the rotor 5 can be measured periodically, during so-called checking periods. These can be predefined and scheduled checking periods. As a variant, a checking period can be initiated at the request of the user. The checking periods are advantageously scheduled or chosen by the user when there is no gaseous flow. Such checking periods are notably advantageous in the case of a pump 1 on magnetic bearings 16.

During these checking periods, at least one command to offset the axis of rotation I-I of the rotor 5 can be sent to the magnetic bearings 16 by the monitoring unit 19.

According to one embodiment, the method can comprise at least one preliminary step to check whether at least one condition is fulfilled before commanding an offset. It can notably be a temperature condition. In particular, in a nonlimiting manner, it can be checked if the temperature T° of the rotor 5 is stabilized or decreasing. The temperature T° of the rotor 5 can be considered stabilized if it does not fluctuate, and in particular does not increase by a predefined degree quantity over a determined period. As an illustrative example, the temperature T° of the rotor 5 can be considered stabilized if it does not increase by more than 0.1° over the last 10 minutes.

Other conditions can be checked as a variant or in addition to the stabilized or decreasing temperature T° of the rotor 5 to allow the offsetting command.

The offsetting of the axis of rotation I-I of the rotor 5 can fill, for example, a gap between the cylindrical skirt of the rotor 5 (such as a Holweck skirt 14) and a possible deposition on the stator 3, notably a part of the stator 3 facing the cylindrical skirt (Holweck skirt) 14. There will then be a friction on the skirt 14 of the rotor 5 and a local overheating can occur.

The offsetting command can be performed in a single given direction, this direction being at right angles to the axis of rotation I-I. As a variant, the offsetting command can be performed in several directions, or on a circular trajectory.

When the axis of rotation I-I is offset, the temperature sensor 17 can measure the temperature T° of the rotor 5 and transmit the temperature measurement or measurements T° to the monitoring unit 19.

The duration of the offsetting command is predefined and should be sufficient to allow a measurement of a change of the temperature T° of the rotor 5, for example between three seconds and one minute, even 10 minutes, per direction.

Once the offsetting command is finished, the monitoring unit 19 can control the magnetic bearings 16 such that the axis of rotation I-I reverts to its central or substantially central position. The mechanical play is recreated, and the friction disappears.

It is thus possible to detect an excessive deposition in the pump 1 without waiting for the continuous friction to impose an emergency stoppage of the pump 1. Simple cleaning maintenance of the pump 1 should simply be scheduled rapidly.

Whether the temperature T° of the rotor 5 is measured continuously or during a checking period, the method comprises the following steps.

From temperature measurements T° received from the temperature sensor 17, the monitoring unit 19 can calculate a drift of the temperature with respect to time

$$\frac{dT °}{dt} .$$

The curve C2, in broken lines in FIG. 2, shows the trend of the drift of the temperature with respect to time

$$\frac{dT °}{dt}$$

as a function of the time t.

According to an exemplary embodiment, the drift of the temperature with respect to time

$$\frac{dT °}{dt}$$

can be calculated at different frequencies, according to several time bases. For example, the drift

$$\frac{dT °}{dt}$$

can be calculated every millisecond, every second, every ten seconds, or another frequency. An average of several drifts

$$\frac{dT °}{dt}$$

calculated at different frequencies/time bases, can be calculated. Hereinafter in the description, the calculated value of the drift

$$\frac{dT °}{dt}$$

refers to a drift of the temperature with respect to time

$$\frac{dT °}{dt}$$

calculated at an instant t or with an average of several drifts.

The monitoring unit 19 can then compare the calculated value of the drift

$$\frac{dT °}{dt}$$

to a predefined threshold s, s(Imotor).

The threshold s, s(Imotor) can be set or, as a variant, be variable. It is also possible to envisage that the predefined threshold s be set at least during a first iteration of the method, then the predefined threshold s(Imotor) can be variable during at least one next iteration of the method. In this case, the set predefined threshold s is preferably greater than the variable predefined threshold s(Imotor).

As an example, the threshold s, s(Imotor) can be less than or equal to 2° C./min.

In particular, when the threshold s is set it can be 2° C./min.

When the threshold s(Imotor) is variable, the range that can be envisaged can be variable. For example, the variable threshold s(Imotor) can lie between 0.3° C./min and 2° C./min.

When the threshold s(Imotor) is variable, it can be a function at least of a motor current. This is the current consumed by the motor of the pump 1 driving the rotor 5 in rotation.

The variable predefined threshold s(Imotor) can be calculated according to the following formula (1):

$$s ( Imotor ) = a + b \times \frac{Imotor}{I max} ° C . / min . \qquad ( 1 )$$

In this formula, a corresponds to a first coefficient, b corresponds to a second coefficient, Imotor corresponds to the motor current, Imax corresponds to the maximum value of the motor current. The motor current for example lies between 0 A and 10 A.

The first coefficient a can correspond to the minimum threshold value that can be envisaged, that is to say the minimum bound of the threshold range. According to the preceding range example [0.3° C.-2° C.], the minimum bound being 0.3° C., the first coefficient a can be equal to 0.3.

The second coefficient b can be chosen as a function of the chosen first coefficient a and such that when the motor current Imotor is at the maximum value Imax, the value of the threshold s (Imax) is maximal, that is to say equal to the maximum bound of the threshold range. Thus, when the motor current Imotor is at the maximum value Imax, the formula (1) becomes:

$$s ( I max ) = a + b \times \frac{I max}{I max} ° C . / min . \qquad ( 1 )$$

The second coefficient b can then be calculated according to the following formula (2):

$$b = s ( I max ) - a \qquad ( 2 )$$

Thus, the second coefficient b corresponds to the maximum bound of the threshold range from which the first coefficient a is removed. According to the preceding range example [0.3° C.-2° C.], the maximum bound is 2° C./min, and, for a value of the first coefficient a of 0.3, the second coefficient b is equal to 1.7.

The variable threshold s(Imotor) can further depend on one or more other criteria. These can be for example a nature of the pumped gases and/or the temperature T° of the rotor 5/representative of the temperature of the rotor 5, at the instant t when the drift

$$\frac{dT °}{dt}$$

is calculated. In particular, the first coefficient a can be increased or reduced. The incrementing or decrementing of the first coefficient a can be of the order of a tenth.

For example, the higher the temperature of the rotor 5 becomes, the more the threshold s(Imotor) can lower and/or at least the first coefficient a can be reduced. Notably, at least the first coefficient a can be reduced when the temperature T° of the rotor 5/representative of the temperature of the rotor 5 measured at the instant t when the drift

$$\frac{dT °}{dt}$$

is calculated increased or reach a predetermined temperature. Conversely, the first coefficient a can be increased when the temperature T° of the rotor 5/representative of the temperature of the rotor 5, measured at the instant t when the drift

$$\frac{dT °}{dt}$$

is calculated, decreases or passes below the predetermined temperature. The second coefficient b can possibly also be modified according to the temperature of the rotor 5.

As an illustrative and nonlimiting example, for a temperature T° of the rotor 5 at the instant t when the drift

$$\frac{dT °}{dt}$$

is calculated less than 130° C., for example 100° C., the first coefficient a can be 0.3 as previously developed. According to another example, for a temperature T° of the rotor 5 at the instant t when the drift

$$\frac{dT °}{dt}$$

is calculated equal to or greater than 130° C., the first coefficient a can be reduced for example to 0.2.

As a variant or in addition to the inclusion of the temperature T° of the rotor 5, it is also possible to envisage adapting the variable threshold s(Imotor), and notably at least the first coefficient a, as a function of the nature of the pumped gases.

More specifically, a so-called light gas is highly conductive and makes it possible to enhance the cooling of the rotor 5, and in this case, the variable threshold s(Imotor) or the first coefficient a can be lowered, for example by a tenth. The so-called light gases are gases that are lighter than air, such as, for example, helium (symbol He), hydrogen (symbol H).

On the contrary, in the case of a so-called heavy gas, the variable threshold s(Imotor) or the first coefficient a can be increased, for example by a tenth. The so-called heavy gases are gases that are heavier than air, such as, for example, hydrogen bromide (symbol HBr).

Moreover, based on the results of comparison of the value of the calculated drift

$$\frac{dT °}{dt}$$

to the predefined threshold s, s(Imotor), the monitoring unit 19 can detect or not detect an overheating of the rotor 5. Notably, when the calculated value of the drift

$$\frac{dT °}{dt}$$

is greater than or equal to the predefined threshold s, s(Imotor), the monitoring unit 19 can detect an abnormal overheating representative of a deposition layer.

When such an overheating is detected during a continuous check, the monitoring unit 19 can issue at least one alert signal and/or at least one command signal to stop the pump 1.

Alternatively, if the detection is performed during a checking period, with an offsetting of the axis of rotation I-I, the monitoring unit 19 can issue an alert signal, not involving an immediate stoppage, but only a request for rapid maintenance.

The alert signal (or the rapid maintenance request) and/or the stop command signal can be digital and/or analogue.

The alert signal (or the rapid maintenance request) and/or the stop command signal can be generated at the pump 1 by the monitoring unit 19. It can be a visual and/or sound signal.

The monitoring unit 19 can also transmit the alert signal (or rapid maintenance request) and/or the stop command signal to at least one piece of equipment linked to the monitoring unit 19 of the pump 1. It can be a piece of equipment commonly called a “tool”, and configured to manage a chamber to which the pump 1 is fluidically coupled for the pumping of the gases. The equipment can then decide to command the stoppage of the pump 1 and possibly take all the necessary measures to preserve the piece of equipment, such as cutting the gases injected into the chamber and closing the shut-off valves between the chamber and the pump 1.

According to another example, the monitoring unit 19 can also transmit the alert signal (or rapid maintenance request) and/or stop command signal to a central monitoring unit linked to several pumps 1 or to several pieces of equipment.

Thus, by monitoring the trend of the temperature T° of the rotor 5 and more specifically the drift of the temperature as a function of time

$$\frac{dT °}{dt}$$

It is possible to simply detect the appearance of a deposition layer when this drift

$$\frac{dT °}{dt}$$

reaches the set predefined threshold s, or variable predefined threshold s(Imotor). In addition, when the temperature sensor 17 is already used for a temperature regulation of the pump 1, it is not necessary to add another temperature sensor for this function. The user can thus be alerted that a cleaning of the pump 1 is necessary and/or that the pump 1 can be stopped and the chamber isolated in order to allow the cleaning of the pump 1.

1-13. (canceled)

14. A method for detecting a deposition layer in a turbomolecular vacuum pump comprising a stator and a rotor configured to revolve in the stator, and at least one temperature sensor arranged in the stator so as to measure a temperature representative of a temperature of the rotor and configured to transmit at least one temperature measurement to a monitoring unit of said pump, the method comprising:
measuring, via the at least one temperature sensor, said temperature and transmitting the measurement of said temperature to the monitoring unit;
calculating from the measurement of said temperature transmitted by the at least one temperature sensor, a drift of the temperature with respect to time via the monitoring unit;
comparing, via the monitoring unit, a value of said calculated drift to a predefined threshold; and
detecting via the monitoring unit, when the value of said calculated drift is greater than or equal to the predefined threshold, an abnormal overheating representative of a deposition layer and issuing at least one alert signal and/or at least one command signal to stop said pump.

15. The detection method according to claim 14, wherein said pump comprises magnetic bearings configured to guide the rotor in rotation about an axis of rotation, and wherein the monitoring unit controls the magnetic bearings to offset the axis of rotation for a predefined time in at least one direction at right angles to the axis of rotation, and the temperature is measured at least when the axis of rotation is offset.

16. The detection method according to claim 14, wherein the alert signal and/or the stop command signal is generated at said pump and/or the monitoring unit transmits the alert signal and/or the stop command signal to at least one piece of equipment linked to said pump.

17. The detection method according to claim 14, wherein the predefined threshold is less than or equal to 2° C./min.

18. The detection method according to claim 14, wherein the predefined threshold is between 0.3° C./min and 2° C./min.

19. The detection method according to claim 14, wherein the predefined threshold is set.

20. The detection method according to claim 14, wherein the predefined threshold is variable and a function of a motor current consumed by a motor of said pump configured to drive the rotor in rotation.

21. The detection method according to claim 14, wherein the predefined threshold is set at least in a first iteration of the method, and the predefined threshold is variable in at least one next iteration of the method, the set predefined threshold being greater than the variable predefined threshold.

22. The detection method according to claim 21, wherein the variable predefined threshold is calculated according to the formula:
$$s ( Imotor ) = a + b \times \frac{Imotor}{I max} ° \frac{C}{min}$$
wherein a corresponds to a first coefficient, b corresponds to a second coefficient, Imotor corresponds to a motor current, and Imax corresponds to the maximum value of the motor current.

23. The detection method according to claim 22, wherein:
said variable predefined threshold is chosen from at least one predefined threshold range, and
the first coefficient is equal to a minimum bound of the threshold range, and the second coefficient is equal to a maximum bound of the threshold range minus the first coefficient.

24. The detection method according to claim 22, wherein the variable predefined threshold depends also on at least one criterion from among a nature of pumped gases and/or the temperature representative of the temperature of the rotor at an instant when said drift is calculated.

25. The detection method according to claim 24, wherein the first coefficient is reduced when said temperature measured at the instant when said drift is calculated is greater than or equal to a predetermined temperature.

26. A turbomolecular vacuum pump configured to at least partly implement the detection method according to claim 13, said pump comprising:
the stator;
the rotor configured to revolve in the stator;
the at least one temperature sensor arranged in the stator and configured to measure the temperature representative of the temperature of the rotor;
the monitoring unit, the at least one temperature sensor being configured to transmit the measurement of said temperature to the monitoring unit, and the monitoring unit comprising at least one processing element configured to:
calculate, from measurements of said temperature transmitted by the at least one temperature sensor, the drift of the temperature with respect to time,
compare the value of said calculated drift to the predefined threshold, and
when the value of said calculated drift is greater than or equal to the predefined threshold, detect the abnormal overheating representative of the deposition layer and issue the at least one alert signal and/or the at least one command signal to stop said pump.

27. The turbomolecular vacuum pump according to claim 26, wherein the temperature sensor is chosen from among an infrared sensor, a magnetothermal sensor, and a positive temperature coefficient probe.
